(19) United States
(12) Patent Application Publication
(10) Pub. No.: US 2011/0133376 A1
(43) Pub. Date: Jun. 9, 2011

(54) INJECTION MOULDING SOFT ELASTOMERS

(76) Inventor: Padraic Hackett, Dublin (IE)

(21) Appl. No.: 12/712,841

(22) Filed: Feb. 25, 2010

(30) Foreign Application Priority Data
Dec. 9, 2009 (IE) S2009/0928
Dec. 18, 2009 (IE) S2009/0951

(51) Int. Cl. B29C 45/14; B29C 45/40; F16F 1/36

(52) U.S. Cl. 267/145; 264/259; 264/257; 264/273; 264/154

(57) ABSTRACT

A fabric web is led between mould parts which are subsequently closed. A liquid elastomer is injected into the mould for forming a soft elastomeric product bonded to the fabric web. As the mould is opened ejector pins on one mould part clamp the web against the other mould part for stripping the soft elastomeric product from the mould. After disengagement of the ejector pins the web is advanced to discharge the soft elastomeric product from the mould.

### INTRODUCTION

This invention relates to the injection moulding of relatively soft elastomers and gels formed therefrom.

Throughout this patent specification by relatively soft is meant materials with a hardness of 30 Shore A or less. Such materials include gels formed from soft elastomers such as SEBS (Styrene-Ethylene-Butylene-Styrene) copolymers in combination with a plasticizing oil.

The invention is primarily concerned with the manufacture of gel cushion products of the type having a grid-like gel body forming a matrix of open-ended cells. Such gel cushion products are used in the manufacture of cushions, seats, mattresses and the like. An example of such a product is disclosed in EP 2 080 780.

A problem arises with the injection moulding of such gel cushion products in that after each moulding cycle the gel cushion product thus formed tends to firmly grip onto the mould cores which form the cells in the gel body during moulding. This presents a difficulty in ejecting the gel body from the mould to enable a new moulding cycle to commence. Engaging the gel body with ejector pins as the mould opens in a conventional manner does not help, because the gel body simply deforms where engaged by the ejector pins due to the softness of the material.

The present invention is directed towards overcoming this problem.

### SUMMARY OF THE INVENTION

According to the invention there is provided a process for injection moulding a soft elastomeric product including the steps;
positioning a substrate between a complementary pair of mould parts forming a mould;
closing the mould;
injecting liquid elastomer into the mould for forming the soft elastomeric product bonded to the substrate; and
opening the mould whilst holding the substrate for stripping the product from the mould as the mould is opening.

The problem of ejecting the product from the mould is overcome in accordance with this invention by moulding the product onto a substrate and holding the substrate as the mould opens to pull the gel product from the mould. The bonding of the gel product with the substrate needs to be sufficient so that the substrate does not tear away from the product as the product is pulled from the mould.

In one embodiment of the invention the process includes injecting the liquid elastomer through the substrate into the mould.

In another embodiment the process includes clamping the substrate to a first mould part whilst opening the mould.

In a further embodiment the process includes engaging ejector pins mounted on a second mould part with the substrate for clamping the substrate against the first mould part whilst opening the mould.

In a particularly preferred embodiment the process includes engaging the ejector pins with the substrate by extending said ejector pins through openings in the product.

Preferably the process includes engaging the substrate by means of a bulbus head on each ejector pin.

In another embodiment the substrate is a fabric material. The substrate may be a woven, knitted or a non-woven fabric material.

In a further embodiment the substrate is a non-woven polyester material.

In another embodiment the substrate comprises a web and the process includes;
leading the web between the mould parts when said mould parts are in an open position,
halting the web,
closing the mould parts with the web located between the mould parts and passing through a moulding cavity within the mould,
forming the product in the mould cavity bonded to the web, opening the mould, and
advancing the web for discharging the product from the mould on the web.

In another embodiment the substrate is perforated.

In another embodiment the process includes perforating the substrate prior to delivering the substrate to the mould.

In a further embodiment the process includes the step of perforating the substrate within the mould.

In another embodiment the elastomer has a hardness in the range 30 Shore A to 20 Shore 00.

In another embodiment the elastomer has a Shore A hardness of 7 or less.

In a further embodiment the elastomer is selected from the group; SEBS (styrene-ethylene-butylene-styrene), SEEPS (styrene-ethylene-ethylene-propylene-styrene), SEPS (styrene-ethylene-propylene-styrene), TPU (thermoplastic urethanes) and plasticized PVC.

In a preferred embodiment the product is a cushion.

In a particularly preferred embodiment the cushion has a grid-like structure.

In another aspect the invention provides a bedding product incorporating the cushion.

In a preferred embodiment the bedding product is a mattress.

In a further aspect the invention provides a furniture product incorporating the cushion.

In another aspect the invention provides a process for injection moulding a plastics product including these steps;
positioning a substrate between a complementary pair of mould parts forming a mould;
closing the mould;
injecting liquid plastics material into the mould for forming the plastics product bonded to the substrate; and
opening the mould whilst holding the substrate for stripping the product from the mould as the mould is opening.

### BRIEF DESCRIPTION OF THE DRAWINGS

The invention will be more clearly understood by the following description of some embodiments thereof, given by way of example only with reference to the accompanying drawings, in which:

FIG. 1 is a perspective view of a gel cushion product produced by the method of the invention;

FIG. 2 is a plan view of the gel cushion product;

FIG. 3 is an elevational view of the gel cushion product;

FIG. 4 is a side elevational view of the gel cushion product;

FIG. 5 is a schematic illustration of an injection moulding station for forming the gel cushion product;

FIG. 6 is a view similar to FIG. 5 showing the mould for forming the product in another position of use during ejection of the product from the mould; and

FIG. 7 is an enlarged detail perspective view showing engagement of the gel cushion product by ejector pins of the mould during ejection of the gel cushion product from the mould; and

FIGS. 8 to 11 are views of other gel cushion products.

### DETAILED DESCRIPTION OF THE INVENTION

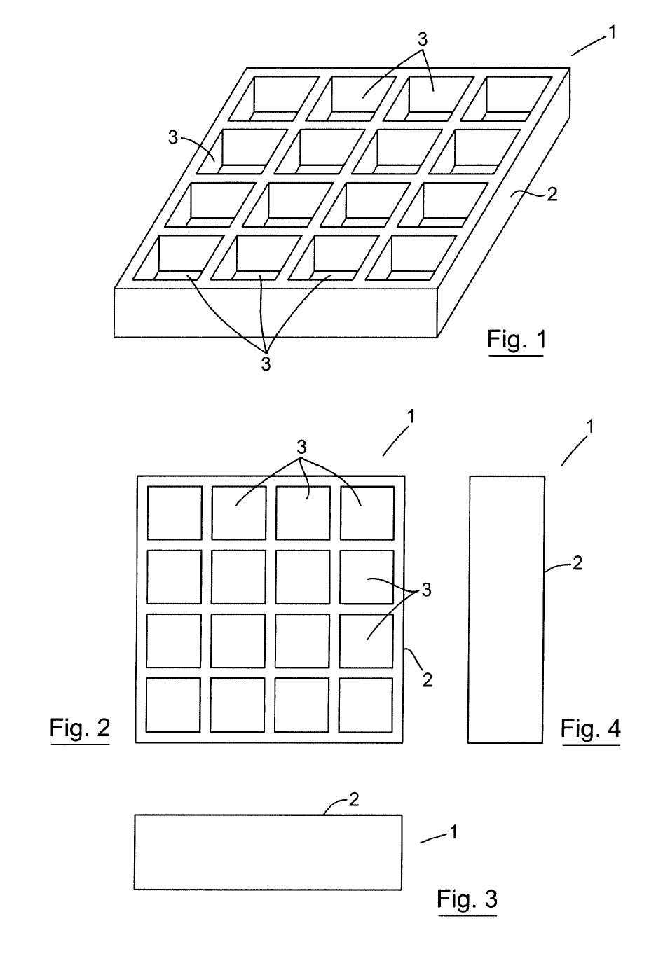

Referring initially to FIGS. 1 to 4, a gel cushion product which is produced by the method of the invention is shown and indicated generally by the reference numeral 1. The product 1 has a grid-like gel body 2 forming a matrix of open-ended cells 3.

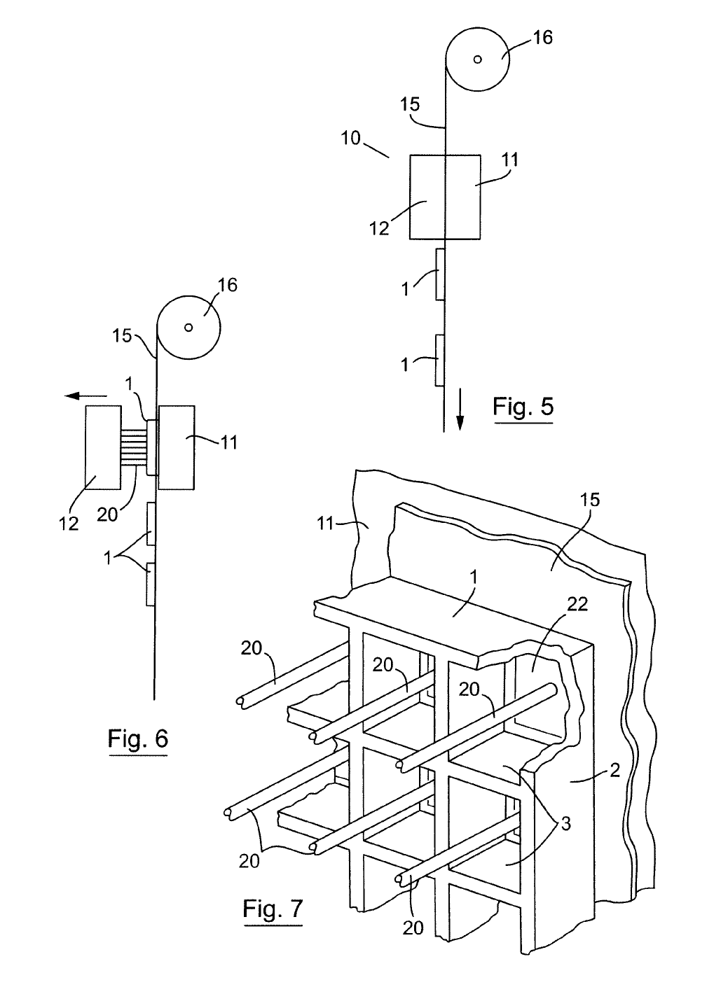

Referring now to FIGS. 5 to 7, there is shown a mould 10. The mould 10 has a fixed mould part 11 and a complementary movable mould part 12 which is movable away from the fixed mould part 11 as shown in FIG. 6 for ejection of the moulded product 1 from the mould 10. A fabric web 15, which may conveniently be a fibrous polyester material, is led from a supply reel 16 and delivered between the mould parts 11, 12. The mould 10 is closed by engaging the movable mould part 12 against the fixed mould part 11 with the fabric web 15 therebetween and passing through a moulding cavity of the mould 10.

Liquid elastomer, such as SEBS for example, is then injected through the fabric web 15 into the moulding cavity, forming the gel cushion product 1 about an array of cell-forming cores mounted on the movable mould part 12 within the moulding cavity and mechanically or chemically binding the cushion product 1 to the fabric web 15.

After cooling and solidifying the gel material within the mould 10, the movable mould part 12 is moved away from the fixed mould part 11 into the open position as shown in FIG. 6. As the mould 10 opens, ejector pins 20 at an outer end of each core in the mould 10 remain in engagement with the web 15 clamping the web 15 against the fixed mould part 11, as shown in FIG. 7. Thus, the cores are pulled away from the gel cushion product 1 as the mould 10 opens, leaving the gel cushion product 1 clamped against the fixed mould part 11 by the ejector pins 20 which extend through the cells 3 to engage the web 15 bonded to the body 2 at inner ends of the cells 3. It will be noted that each ejector pin 20 has an enlarged mushroom head 22. This provides good support for the fabric web 15 and promotes an even pulling of the product from the mould. When the core pins have been disengaged from the product 1 the ejector pins 20 are retracted and the web 15 is advanced to remove the gel cushion product 1 from the mould 10.

Downstream of the mould the moulded gel cushion products 1 are cut away from the web 15 in any suitable manner.

It will be appreciated that a range of suitable elastomers can be used. These include SEBS, SEEPS, SEPS, TPU, plasticized PVC and other elastomers. Thermoplastic or thermosetting elastomers can be used. Silicone rubbers can also be used in other than bedding related applications.

The relatively soft elastomers used will typically be in the range 30 Shore A down to 20 Shore 00.

Regarding the fabric web 15 knitted, woven and non-woven fabrics can be used. Successful mechanical bonds can be achieved between the elastomer and a natural fabric such as cotton and with artificial fabrics. If required, to improve the mechanical bond the fabric web 15 may be perforated either prior to or during the moulding. Ribs or other protrusions or voids may be formed in the fabric web 15 to enhance the bonding with the polymer. The bond can also be chemical if a suitable combination of polymer and fabric web 15 is used—the combination of a polyolefin based fabric with a SEBS polymer is a typical example of this.

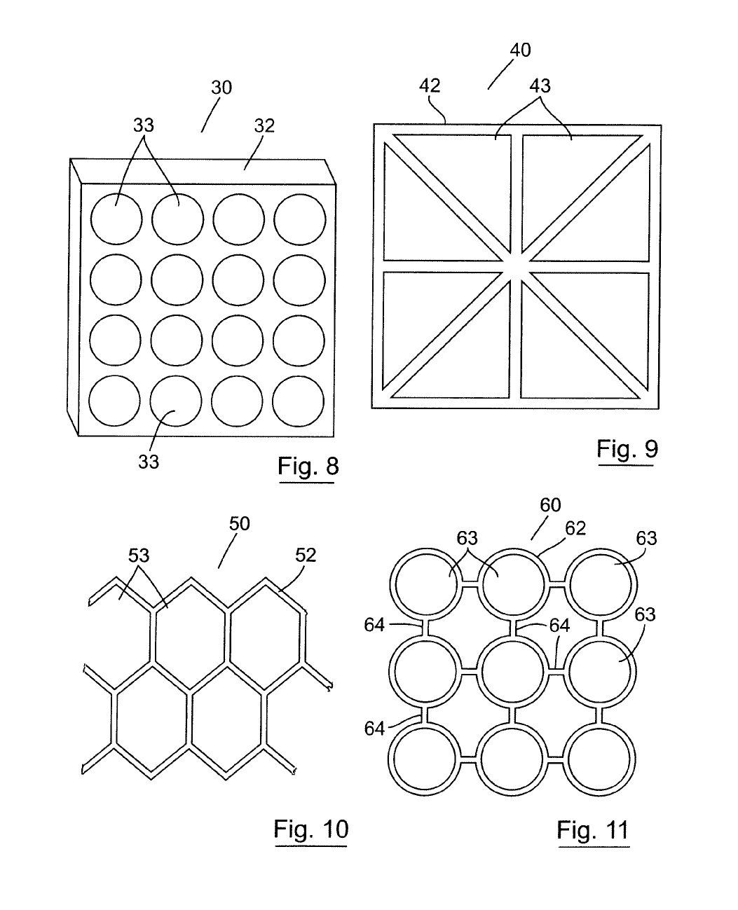

Referring now to FIGS. 8 to 11, these show examples of various other gel cushion configurations. FIG. 8 shows a gel cushion product 30 having a gel body 32 with cylindrical open-ended cells 33. FIG. 9 shows a gel cushion product 40 having a gel body 42 with triangular open-ended cells 43. FIG. 10 shows a gel cushion product 50 having a gel body 52 with hexagonal open-ended cells 53. FIG. 11 shows a gel cushion product 60 having a gel body 62 with cylindrical open-ended cells 63 interconnected by webs or flanges 64. Any suitable openings may be provided in the product. These openings may form a regular repeating pattern or not as required. The gel cushion may be any desired shape.

Advantageously as the process of the invention can be fully automated it is significantly cheaper than the traditional ways of manufacturing such gel products such as pouring the liquid polymer into heated aluminium moulds. Further, the ejection method allows the design of thinner walled components with minimum draft angles. This will save material as the same mechanical properties in the end product can be achieved with less polymer material, which is expensive. Conveniently the process of the invention does not require any post lamination of fabric on one side of the product.

While the invention has been described herein applied to the injection moulding of relatively soft elastomers, it is envisaged that it could have wider applications where it may be desirable to injection mould a product onto a substrate and hold the substrate, rather than the product, for stripping the product from the mould when the mould is opening.

The invention is not limited to the embodiments hereinbefore described which may be varied in both construction and detail within the scope of the appended claims.

1. A process for injection moulding a soft elastomeric product including the steps;
positioning a substrate between a complementary pair of mould parts forming a mould;
closing the mould;
injecting liquid elastomer into the mould for forming the soft elastomeric product bonded to the substrate; and
opening the mould whilst holding the substrate for stripping the product from the mould as the mould is opening.

2. The process as claimed in claim 1 wherein the process includes injecting the liquid elastomer through the substrate into the mould.

3. The process as claimed in claim 1 wherein the process includes clamping the substrate to a first mould part whilst opening the mould.

4. The process as claimed in claim 3 wherein the process includes engaging ejector pins mounted on a second mould part with the substrate for clamping the substrate against the first mould part whilst opening the mould.

5. The process as claimed in claim 4 wherein the process includes engaging the ejector pins with the substrate by extending said ejector pins through openings in the product.

6. The process as claimed in claim 4 wherein the process includes engaging the substrate by means of a bulbus head on each ejector pin.

7. The process as claimed in claim 1 wherein the substrate is a fabric material.

8. The process as claimed in claim 7 wherein the substrate is a non-woven fabric material.

9. The process as claimed in claim 8 the substrate is a non-woven polyester material.

10. The process as claimed in claim 1 wherein the substrate comprises a web and the process includes;
leading the web between the mould parts when said mould parts are in an open position,
halting the web,
closing the mould parts with the web located between the mould parts and passing through a moulding cavity within the mould,
forming the product in the mould cavity bonded to the web, opening the mould, and
advancing the web for discharging the product from the mould on the web.

11. The process as claimed in claim 1 wherein the substrate is perforated.

12. The process as claimed in claim 11 wherein the process includes perforating the substrate prior to delivering the substrate to the mould.

13. The process as claimed in claim 11 wherein the process includes the step of perforating the substrate within the mould.

14. The process as claimed in claim 1 wherein the elastomer has a hardness in the range 30 Shore A to 20 Shore 00.

15. The process as claimed in claim 15 wherein the elastomer has a Shore A hardness of 7 or less.

16. The process as claimed in claim 1 wherein the elastomer is selected from the group; SEBS (styrene-ethylene-butylene-styrene), SEEPS (styrene-ethylene-ethylene-propylene-styrene), SEPS (styrene-ethylene-propylene-styrene), TPU (thermoplastic urethanes) and plasticized PVC.

17. The process as claimed in claim 1 wherein the product is a cushion.

18. The process as claimed in claim 17 wherein the cushion has a grid-like structure.

19. A bedding product incorporating the cushion claimed in claim 17.

20. The bedding product as claimed in claim 19 wherein the bedding product is a mattress.

21. A furniture product incorporating the cushion claimed in claim 17.
